(19) United States
(12) Patent Application Publication
(10) Pub. No.: US 2026/0104779 A1
(43) Pub. Date: Apr. 16, 2026

(54) AUTOMATICALLY ENHANCING UI ELEMENTS OF A CONTENT PLATFORM IN RESPONSE TO AN AUDIO-VISUAL CUE

(71) Applicant: Google LLC, Mountain View, CA (US)

(72) Inventors: Thomas F Moran, III, Moraga, CA (US); Jackelyn Shen, Santa Clara, CA (US); Priyanka Agarwal, Cupertino, CA (US); Xiaoli He, Mountain View, CA (US)

(21) Appl. No.: 18/917,298

(22) Filed: Oct. 16, 2024

Related U.S. Application Data
(60) Provisional application No. 63/590,973, filed on Oct. 17, 2023.

(51) Int. Cl. G06F 3/0481

(52) U.S. Cl. CPC G06F 3/0481

(57) ABSTRACT

Methods and systems for automatically enhancing UI elements of a content platform in response to an audio-visual cue are provided herein. A user interface (UI) of a content platform to play a media item is provided for presentation on a user device of a user. An occurrence of an audio-visual cue, within the media item, for the user to engage with the UI of the content platform is detected during playback of the media item via the UI of the content platform. A UI element corresponding to the audio-visual cue for the user to engage with the UI of the content platform is identified among the plurality of UI elements of the UI. Causing the corresponding UI element to be enhanced on the UI of the content platform.

### RELATED APPLICATIONS

This application claims the benefit of U.S. Provisional Patent Application No. 63/590,973, filed Oct. 17, 2023, entitled “ AUTOMATICALLY ENHANCING UI ELEMENTS OF A CONTENT PLATFORM IN RESPONSE TO AN AUDIO-VISUAL CUE,” which is incorporated by reference herein.

### TECHNICAL FIELD

Aspects and implementations of the present disclosure relate to automatically enhancing UI elements of a content platform in response to an audio-visual cue.

### BACKGROUND

Content creators may utilize a platform (e.g., a content platform) to transmit (e.g., stream) media items to client devices connected to the platform via a network. A media item can include a video, an audio item, and/or a slide presentation, in some instances. Users can consume the transmitted media items via a user interface (UI) provided by the platform.

### SUMMARY

The below summary is a simplified summary of the disclosure to provide a basic understanding of some aspects of the disclosure. This summary is not an extensive overview of the disclosure. It is intended neither to identify critical elements of the disclosure, nor to delineate any scope of the particular implementations of the disclosure or any scope of the claims. Its sole purpose is to present some concepts of the disclosure in a simplified form as a prelude to the more detailed description that is presented later.

Aspects of the disclosure provide a system, a method and a computer-readable medium for automatically enhancing UI elements of a content platform in response to an audio-visual cue. In an implementation, a method includes providing, for presentation on a user device of a user, a user interface (UI) of a content platform to play a media item (or stream a live media item), the UI comprising a plurality of UI elements. The method further includes detecting, during playback of the media item (or streaming of the live media item) via the UI of the content platform, an occurrence of an audio-visual cue, within the media item, for the user to engage with the UI of the content platform. The method further includes identifying, among the plurality of UI elements of the UI, a UI element corresponding to the audio-visual cue for the user to engage with the UI of the content platform. The method further includes causing the corresponding UI element to be enhanced on the UI of the content platform.

In some implementations, detecting the occurrence of the audio-visual cue within the media item comprises accessing a media metadata data structure comprising a plurality of entries each associated with one of a plurality of media items; identifying, using an entry associated with the media item in the media metadata data structure, a plurality of visual enhancement annotations each corresponding to one of a plurality of audio-visual cues; and selecting, at a first point in time during the playback of the media item, one of the plurality of visual enhancement annotations that has a timestamp matching the first point in time, the selected visual enhancement annotation being associated with the audio-visual cue in the media metadata data structure.

In some implementations, the UI element corresponding to the audio-visual cue is associated with the selected visual enhancement annotation in the media metadata data structure.

In some implementations, the corresponding UI element is caused to be enhanced on the UI of the content platform using a visual enhancement setting of the selected visual enhancement annotation to enhance the corresponding UI element. The visual enhancement setting dictates how to enhance the corresponding UI element.

In some implementations, the visual enhancement setting is one of: illuminating the corresponding UI element or pixels surrounding the corresponding UI element, animating the corresponding UI element, or adding a message next to the corresponding UI element.

In some implementations, the corresponding UI element is one of a like button, a share button, a subscribe button, a join button, a comment section, or a description section.

In some implementations, the method further includes generating the plurality of visual enhancement annotations for the media item and adding the entry comprising the plurality of visual enhancement annotations for the media item to the media metadata data structure. Each of the plurality of visual enhancement annotations identifies a respective audio-visual cue, a timestamp associated with an occurrence of the respective audio-visual cue within the media item, and a UI element associated with the respective audio-visual cue.

In some implementations, the method further includes detecting one or more actions of the user and prior to causing the corresponding UI element to be enhanced, verifying that enhancing the corresponding UI element is consistent with the one or more actions of the user.

In some implementations, the method further includes ensuring that a number of times the corresponding UI element is enhanced during payback of the media item is below a threshold number.

In some implementations, the corresponding UI element is enhanced during payback of the media item according to a priority order.

In some implementations, the method further includes determining whether a UI enhancement feature is enabled or disabled based on user input or capability of the user device and responsive to determining that the UI enhancement feature is enabled, enhancing the corresponding UI element on the UI of the content platform.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 illustrates an example system architecture, in accordance with implementations of the present disclosure.

FIG. 2A is a block diagram illustrating an example cue detection engine for automatically enhancing UI elements or panels of a content platform in response to an audio-visual cue, in accordance with implementations of the present disclosure.

FIG. 2B illustrates an example media metadata data structure used to identify audio-visual cue in media items, in accordance with implementations of the present disclosure.

FIG. 3 illustrates an example user interface (UI) in which a subscribe UI element is automatically enhanced, in accordance with implementations of the present disclosure.

FIG. 4 illustrates an example UI in which a description UI element is automatically enhanced, in accordance with implementations of the present disclosure.

FIG. 5 illustrates an example UI in which a like UI element is automatically enhanced, in accordance with implementations of the present disclosure.

FIG. 6 illustrates an example UI in which a share UI element is automatically enhanced, in accordance with implementations of the present disclosure.

FIG. 7 illustrates an example UI in which a join UI element is automatically enhanced, in accordance with implementations of the present disclosure.

FIG. 8 illustrates an example UI in which a comment UI element is automatically enhanced, in accordance with implementations of the present disclosure.

FIG. 9 illustrates an example UI in which a UI panel is automatically enhanced, in accordance with implementations of the present disclosure.

FIG. 10 depicts a flow diagram of an example method for automatically enhancing UI elements of a content platform in response to an audio-visual cue, in accordance with implementations of the present disclosure.

FIG. 11 is a block diagram illustrating an exemplary computer system, in accordance with implementations of the present disclosure.

### DETAILED DESCRIPTION

Aspects of the present disclosure relate to automatically enhancing user interface (UI) elements of a content platform in response to an audio-visual cue. A platform (e.g., a content platform, etc.) can enable a content creator to upload a media item (e.g., a video) for consumption by another user of the platform. For example, a first user, such as a content creator, can provide (e.g., upload) a media item to a content platform to be available to other users. A second user of the content platform can access the media item provided by the first user via a user interface (UI) provided by the content platform at a client device associated with the second user. The UI of the content platform includes various user interface (UI) elements that allow the second user to engage and/or show support for the first user and their media items (or content). The UI elements can include, for example, approve/disapprove buttons, subscribe button, share button, join button, etc. Typically, the UI of the platform has been designed to immerse the second user into the media item. However, due to constant distractions such as text messages, email notifications, social media notifications, and Internet browsing, the second user may not be completely focused on the media item being played and may not react to the cues provided by the first user within the media item. As such, content creator may not receive expected viewer encouragement, engagement, and/or support for their media items. Accordingly, computing resources consumed by content creators for including cues in media items and computing resources consumed by viewers for playing the media items are not fully realized.

Aspects of the present disclosure address the above and other deficiencies by automatically enhancing UI elements of a content platform in response to an audio-visual cue. In some implementations, during playback of a media item, an occurrence of an audio-visual cue is detected. The audio-visual cue may indicate a cue to either like, share, subscribe, comment, or etc. Each of the audio-visual cues references a UI element of the UI of the platform (e.g., an approve button, a subscribe button, save for later button, etc.). In some implementations, a data structure is maintained to provide correlations between occurrences of audio-visual cues and respective UI elements. Once the UI element of the UI of the platform associated with the audio-visual cue is identified, the UI element of the UI of the platform is visually enhanced to bring attention to the UI element (e.g., by illuminating the UI element or pixels surrounding the UI element, animating the UI element, adding a message next to the UI element, etc.).

Accordingly, aspects of the present disclosure cover techniques that enable a content creator to encourage users of the platform to engage with the user interface playing the content creator's media item by drawing their attention to various user interface elements that can allow the users to demonstrate their encouragement, engagement, and/or support for the content creator and the content creator's media item, thereby resulting in better realization of the computing resources consumed by the content creator to include cues in the content creator's media item and the computing resources consumed by users to play the content creator's media item.

Although the description herein often refers to video as an example type of media item, it is appreciated that aspects and implementations of the present disclosure can apply to other types of media items such as audio, slide presentations, images, and other media without deviating from the scope of the present disclosure.

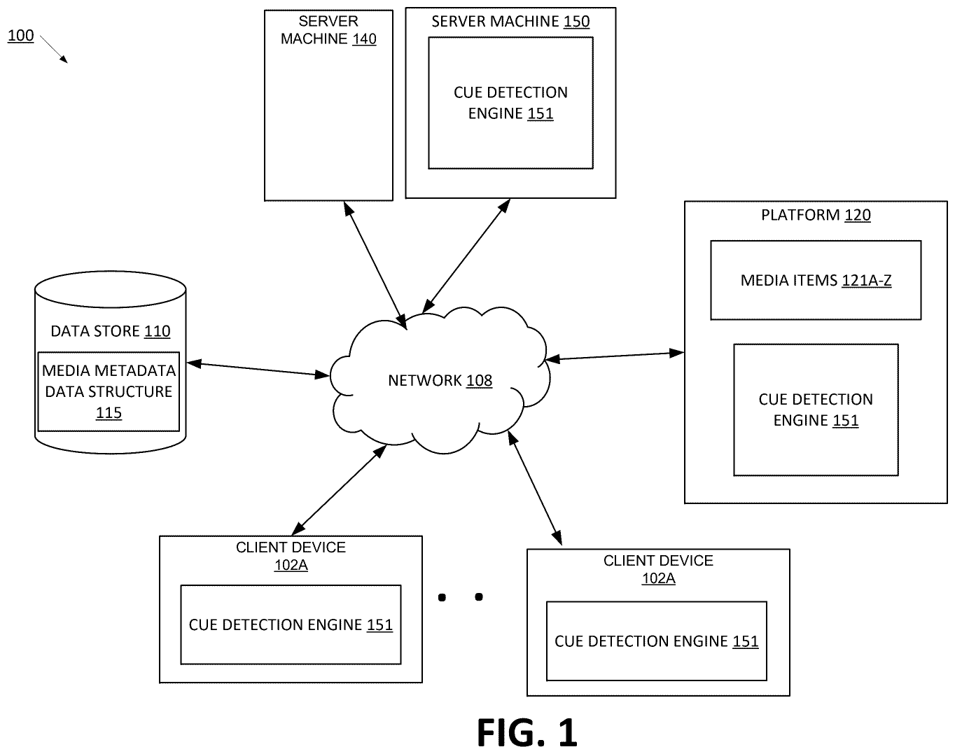

FIG. 1 illustrates an example system architecture 100, in accordance with implementations of the present disclosure. The system architecture 100 (also referred to as “system” herein) includes client devices 102A-N, a data store 110, a platform 120, and/or a server machine 150, each connected to a network 108. In implementations, network 108 can include a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long Term Evolution (LTE) network), routers, hubs, switches, server computers, and/or a combination thereof.

In some embodiments, platform 120 can be a content sharing platform that allows users to consume, upload, share, search for, approve of (“like”), dislike, and/or comment on media items 121. Platform 120 can include a website (e.g., a webpage) or application back-end software used to provide users access to media items 121A-Z (e.g., via client devices 102A-N). A media item of media items 121A-Z can be consumed via the Internet or via a mobile device application, such as a content viewer (not shown) of client device 102A-N. In some embodiments, a media item of media items 121A-Z can correspond to a media file (e.g., a video file, and audio file, etc.). In other or similar embodiments, a media item of media items 121A-Z can correspond to a portion of a media file (e.g., a portion or a chunk of a video file, an audio file, etc.). For example, media items 121A-Z may correspond to a short-form video, long-form video, live video (or stream), 360-degree video, interactive video, branded video, documentary video, etc. As discussed previously, a media item of media items 121A-Z can be requested for presentation to users of the platform by a user of platform 120. As used herein, “media,” media item,” “online media item,” “digital media,” “digital media item,” “content,” and “content item” can include an electronic file that can be executed or loaded using software, firmware or hardware configured to present the digital media item to an entity. In one implementation, platform 120 can store the media items 121A-Z using the data store 110. In another implementation, platform 120 can store media items 121A-Z or fingerprints as electronic files in one or more formats using data store 110. Platform 120 can provide media item of media items 121A-Z to a user associated with a client device (e.g., client device 102A) by allowing access to media item of media items 121A-Z (e.g., via a content sharing platform application), transmitting the media item of media items 121A-Z to the client device 102A, and/or presenting or permitting presentation of the media item of media items 121A-Z at a display device of client device 102A.

In some embodiments, media item of media items 121A-Z can be a video item. A video item refers to a set of sequential video frames (e.g., image frames) representing a scene in motion. For example, a series of sequential video frames can be captured continuously or later reconstructed to produce animation. Video items can be provided in various formats including, but not limited to, analog, digital, two-dimensional, and three-dimensional video. Further, video items can include movies, video clips, video streams, or any set of images (e.g., animated images, non-animated images, etc.) to be displayed in sequence. In some embodiments, a video item can be stored (e.g., at data store 110) as a video file that includes a video component and an audio component. The video component can include video data that corresponds to one or more sequential video frames of the video item. The audio component can include audio data that corresponds to the video data.

In some implementations, data store 110 is a persistent storage that is capable of storing data as well as data structures to tag, organize, and index the data. Data store 110 can be hosted by one or more storage devices, such as main memory, magnetic or optical storage based disks, tapes or hard drives, NAS, SAN, and so forth. In some implementations, data store 110 can be a network-attached file server, while in other embodiments, data store 110 can be some other type of persistent storage such as an object-oriented database, a relational database, and so forth, that may be hosted by platform 120 or one or more different machines coupled to platform 120 via network 108. Data store 110 can include a media cache that stores copies of media items that are received from platform 120. In one example, media item of media items 121A-Z can be a file that is downloaded from platform 120 and can be stored locally in media cache. In another example, media item of media items 121A-Z can be streamed from platform 120 and can be stored as an ephemeral copy in memory of one or more of server machine 130-150.

The client devices 102A-N can each include computing devices such as personal computers (PCs), laptops, mobile phones, smartphones, tablet computers, netbook computers, network-connected televisions, virtual reality headset, etc. In some implementations, client devices 102A-N may also be referred to as “user devices.” Client devices 102A-N can include a content viewer. In some implementations, a content viewer can be an application that provides a user interface (UI) for users to view or upload content, such as images, videos, web pages, documents, etc. For example, the content viewer can be a web browser that can access, retrieve, present, and/or navigate content (e.g., web pages such as Hyper Text Markup Language (HTML) pages, digital videos, etc.) served by a web server. The content viewer can render, display, and/or present the content to a user. The content viewer can also include an embedded media player (e.g., a Flash® player or an HTML5 player) embedded in a web page (e.g., a web page that may provide information about a product sold by an online merchant). In another example, the content viewer can be a standalone application (e.g., a mobile application or app) that allows users to view digital videos (e.g., digital videos, digital images, electronic books, etc.). According to aspects of the disclosure, the content viewer can be a content platform application for users to record, edit, and/or upload content for sharing on platform 120. As such, the content viewers and/or the UI associated with the content viewer can be provided to client devices 102A-N by platform 120. In one example, the content viewers may be embedded media players that are embedded in web pages provided by platform 120.

Platform 120 can include multiple channels (e.g., channels A through Z). A channel can include one or more media items of media items 121A-Z available from a common source or having a common topic, theme, or substance. Media item of media items 121A-Z can be digital content chosen by a user, digital content made available by a user, digital content uploaded by a user, digital content chosen by a content provider, digital content chosen by a broadcaster, etc. For example, a channel can include videos Y and Z. A channel can be associated with an owner, who is a user that can perform actions on the channel. Different activities can be associated with the channel based on the owner's actions, such as the owner making digital content available on the channel, the owner selecting (e.g., liking) digital content associated with another channel, the owner commenting on digital content associated with another channel, etc. The activities associated with the channel can be collected into an activity feed for the channel. Users, other than the owner of the channel, can subscribe to one or more channels in which they are interested. The concept of “subscribing” can also be referred to as “liking,” “following,” “friending,” and so on.

In some embodiments, system 100 can include one or more third party platforms (not shown). In some embodiments, a third party platform can provide other services associated with media items 121. For example, a third party platform can include an advertisement platform that can provide video and/or audio advertisements. In another example, a third party platform can be a video streaming service provider that provides a media streaming service via a communication application for users to play videos, TV shows, video clips, audio, audio clips, and movies, on client devices 102 via the third party platform.

In some embodiments, a client device 102 can transmit a request to platform 120 for access to a media item of media items 121A-Z. Platform 120 can identify the media item of media items 121A-Z of the request (e.g., at data store 110, etc.) and can provide access to the media item of media items 121A-Z via the UIs of the content viewers provided by platform 120.

In some embodiments, the requested media item of media items 121A-Z can have been generated by another client device 102A-N connected to platform 120. For example, client device 102A can generate a video item (e.g., via an audio-visual component, such as a camera, of client device 102A) and provide the generated video item to platform 120 (e.g., via network 108) to be accessible by other users of the platform. In other or similar embodiments, the requested media item of media items 121A-Z can have been generated using another device (e.g., that is separate or distinct from client device 102A) and transmitted to client device 102A (e.g., via a network, via a bus, etc.). Client device 102A can provide the video item to platform 120 (e.g., via network 108) to be accessible by other users of the platform, as described above. Another client device, such as client device 102B, can transmit the request to platform 120 (e.g., via network 108) to access the video item provided by client device 102A, in accordance with the previously provided examples.

As illustrated in FIG. 1, data store 110 can include a media metadata data structure 115 that includes a plurality of entries. Each entry corresponds to a media item of media items 121A-Z and is identified by a media item identifier (e.g., media item ID). Each entry can also include, among other things, a transcription of a respective media item and/or a collection of thumbnails. The transcription (or transcript for simplicity) includes a textual representation of all auditory sounds that occurred in the respective media item, and includes a time (represented as a timestamp) in the respective media item in which a portion of the auditory sound or the auditory sound occurred. In some embodiments, the transcript for a respective media item may be generated during the upload by one or more components of the platform 120, or created by a content creator of the respective media item. The transcript created by the content creator is also referred to as user-generated content (UGC) which includes text overlays that describe or transcribe the audio or action in a video. The collection of thumbnails is a series of still images that represent each video frame of the set of sequential video frames, and includes a time (represented as a timestamp) in the respective media item in which each still image associated with a video frame occurred. In some embodiments, the collection of thumbnails for a respective media item may be generated during the upload by one or more components of the platform 120.

The platform 120 can include a cue detection engine 151. Depending on the embodiment, cue detection engine 151 may be separate from platform 120 at server machine 140 and/or 150 (e.g., service machine 150 of FIG. 1).

Cue detection engine 151 may identify UI elements of the UI of platform 120 to be animated in response to a visual and/or auditory cue (collectively, cues). An auditory cue, for example, refers to a phrase (e.g., “hit the subscribe button”) referencing a respective UI element of the UI of platform 120 (e.g., a subscribe button) that the content creator encourages the users to interact with. A visual cue, for example, refers to a gesture (e.g., a person in the media item with one or more thumbs up) referencing a respective UI element of the UI of platform 120 (e.g., a like button) that the content creator encourages the user to interact with.

In other words, cues referencing a like button can encourage users to like the media item of media items 121A-Z via the like button. Cues referencing a subscribe button can encourage users to subscribe (e.g., for free) to a channel including the media item of media items 121A-Z via the subscribe button. Cues referencing a comment section (or commenting) can encourage users to leave a comment under the media item of media items 121A-Z via the comment section. Cues referencing a description section can encourage users to view the description of the media item of media items 121A-Z via the description section. Cues referencing a share button can encourage users to share the media item of media items 121A-Z with another user via the share button. Cues referencing a join button can encourage users to join (e.g., for a fee) a channel including the media item of media items 121A-Z via a join button. In some embodiments, media item of media items 121A-Z may include a combination of the cues, for example, a cue referencing a like button and a cue referencing a subscribe button indicating that the owner of the media item of media items 121A-Z would like the user to like the media item of media items 121A-Z via the like button and subscribe to the channel including the video item via the subscribe button.

The identified UI elements of the UI of platform 120 can be animated by the cue detection engine 151 (for example, animating a like button, a subscribe button, a comment section, a description section, a share button, or a join button). Each of the identified UI elements of the UI of platform 120 can correspond to an animation type to be used by the cue detection engine 151 (e.g., a like button animation type, a subscribe button animation type, a comment section animation type, a description section animation type, a share button animation type, and a join button animation type). In some embodiments, the plurality of animation types may be stored in data store 110.

Cue detection engine 151 can assign a set of cues to each animation type of the plurality of animation types. In some embodiments, cue detection engine 151 may determine the set of cues to assign to each animation type of the plurality of animation types using a plurality of sample media items. The plurality of sample media items may be stored in data store 110. In particular, cue detection engine 151 can receives, for each animation type of the plurality of animation types, one or more terms of a predetermined length (e.g., one or two words) associated with a respective animation type. For example, cue detection engine 151 may receive, for a like button animation type, “like” or “like button.”

With respect to auditory cues, cue detection engine 151, for each sample media item of the plurality of sample media items, can traverse through a transcript of a respective sample media item and perform pattern matching, using the one or more terms, to obtain a set of possible auditory cues. Each possible auditory cue of the set of possible auditory cues may be a phrase that includes a term (or a portion of the term) of the one or more terms with a predetermined number of words (or characters) before and/or after the term (or a portion of the term).

With respect to visual cues, cue detection engine 151, for each sample media item of the plurality of sample media items, can traverse through a collection of thumbnails of a respective sample media item and perform contextual image classification on each thumbnail of the collection of thumbnails. In some embodiments, the contextual image classification is performed by a machine learning model trained to identify and classify a context of an image. Cue detection engine 151 can perform, for each thumbnail of the collection of thumbnails, pattern matching of a classification of a respective thumbnail with one or more terms, to obtain a set of possible visual cues. Each possible visual cue of the set of possible visual cues may be a thumbnail from a collection of thumbnails of a sample media item of the plurality of sample media items in which the classification matched one or more terms (via pattern matching). Cue detection engine 151 may include the set of possible auditory cues and/or set of possible visual cues into a set of cues.

Cue detection engine 151 may assign each cue of the set of cues a quality score which dictates how contextually similar a respective cue (e.g., “hit the like button” or “thumbnail with thumbs up”) is to a context of the respective animation type (e.g., like button animation type). The quality score may be a value between “0” (indicating that the possible auditory cue is unlikely contextually similar to the animation type) and “1” (indicating that the possible auditory cue is contextually similar to the animation type). The quality score may be assigned manually, or automatically (e.g., via a machine learning model trained to compare context of two or more items). Cue detection engine 151 may reduce, based on the quality score assigned to each cue of the set of cues, the number of cues in the set of cues. For example, if the quality score of a respective cue of the set of cues does not meet or exceed a predetermined quality score threshold value (e.g., 0.7), cue detection engine 151 can remove the respective cue from the set of cues. Cue detection engine 151 can then assign the resulting set of cues to a respective animation type.

For example, the set of cues for an animation type, such as, a subscribe button animation type may include “subscribe button,” “please subscribe,” “subscribe to my channel,” “subs button,” “sub button,” “bell notification,” “hit the bell,” “hit the subscribe button,” “notification bell,” “follow my channel,” “subscribe,” and/or “follow.” In another example, the set of cues for an animation type, such as, a like button animation type may include “like button,” “like my video,” “please like,” “like,” “thumbs up,” “hit the like button,” “smash the like button,” “hit that like button,” and/or “smash that like button.”

Cue detection engine 151 may generate, for each entry of the media metadata data structure 115, one or more visual enhancement annotations. Each visual enhancement annotation refers to data associated with an occurrence of a cue of a set of cues in a media item. This data may include the set of cues, an animation type for each cue in the set of cues, a timestamp associated with a respective occurrence of the cue within the media item, and a quality score assigned to the cue matching a portion of the transcript and/or a thumbnail of the collection of thumbnails..

Regarding an animation type, cue detection engine 151 can traverse a transcript and/or a collection of thumbnails associated with the entry to determine whether a cue assigned to a respective animation type is present, and if so, add it to the visual enhancement annotation.

Regarding a timestamp, a cue can match a portion of the transcript and/or a thumbnail of the collection of thumbnails (e.g., matching portion), cue detection engine 151 can add, to the visual enhancement annotation, a timestamp associated with a respective occurrence of the cue matching a portion of the transcript and/or a thumbnail of the collection of thumbnails. Cue detection engine 151 can append (or store) the visual enhancement annotation to an end of the entry.

Cue detection engine 151 may receive a request to play a media item of media items 121A-Z (e.g., a playback request) on a content viewer of client devices 102A-N. The playback request may identify the media item to be played using a media item ID (e.g., a URL). Cue detection engine 151 can query, in response to the playback request, the media metadata data structure 115 for an entry associated with the media item to be played using the media item ID. Cue detection engine 151 can retrieve, from the entry of the media metadata data structure 115, each visual enhancement annotation appended to the end of the entry to generate a list of visual enhancement annotations.

In some embodiments, the playback request may include a visual enhancement flag indicating whether visual enhancement feature is enabled or disabled for the media item. Visual enhancement flag may be set by the user (e.g., the uploader of the media item). Visual enhancement flag may be cleared due to the user's disabling visual enhancement, due to inability of the client device 102 to handle visual enhancements, due to accessibility features of the client device 102, due to harmful nature of the media item or channel including the media item, or due to specific class of audience (e.g., children). If the visual enhancement flag is set, visual enhancement for a cue is enabled and cue detection engine 151 can retrieve and generate a list of visual enhancement annotations for the media item to be played. Otherwise, if the visual enhancement flag is cleared, visual enhancement for a cue is disabled and cue detection engine 151 cannot retrieve and generate a list of visual enhancement annotations for the media item to be played.

Cue detection engine 151 may modify the list of visual enhancement annotations based on one or more annotation criteria that may limit a number of visual enhancement annotations in the list of visual enhancement annotations.

For example, an annotation criterion, such as, highest quality score per animation type, can dictate that the number of visual enhancement annotations be reduced to include visual enhancement annotations having the highest quality score for a specific animation type. Cue detection engine 151 can modify the list of visual enhancement annotations by selecting, for each animation type, a visual enhancement annotations in the list of visual enhancement annotations associated with a respective animation type with the highest quality score and removing any other visual enhancement annotations in the list of visual enhancement annotations associated with the respective animation type.

In another example, an annotation criterion, such as, distraction per media item limit can dictate that the list of visual enhancement annotations be minimized to include visual enhancement annotations in a first portion of the media item and a last portion of the media item. The first and last portion of the media item may be determined based on length of the media item. For example, an end of the first portion of the media item is a time determined by a percentage of the length of the media item from a beginning of the media item and a beginning of the last portion of the media item is a time determined by a percentage of the length of the media item before an end of the media item. Cue detection engine 151 can modify the list of visual enhancement annotations by selecting the visual enhancement annotations in the first and last portion of the media item. In particular, if a timestamp of a visual enhancement annotation of the list of visual enhancement annotations is between the end of the first portion of the media item and the beginning of the last portion of the media item (e.g., exceeds the time associated with the end of the first portion of the media item and does not exceed the time associated with the beginning of the last portion of media time), the visual enhancement annotation can be removed from the list of visual enhancement annotations. Otherwise, the visual enhancement annotation can remain in the list of visual enhancement annotations.

In yet another example, an annotation criterion, such as, a per media item limit can be a numerical value which indicates a number of visual enhancements for each media item. Cue detection engine 151 can modify the list of visual enhancement annotations by reducing a number of visual enhancement annotations in the list of visual enhancement annotations according to the per media item limit. Cue detection engine 151 may reduce the number of visual enhancement annotations systematically or randomly. Reducing systematically may include removing any visual enhancement annotations according to the per media item limit, removing, after the first visual enhancement annotation of each animation type, any additional visual enhancement annotations for each animation type, and/or any other suitable method for reducing the list of visual enhancement annotations according to the per media item limit.

In still another example, an annotation criterion such as, a per animation type limit can be a numerical value which indicates a number of visual enhancements for each animation type. Cue detection engine 151 can modify the list of visual enhancement annotations by reducing, for each animation type, a number of visual enhancement annotations associated with a respective animation type according to the per animation type limit. Cue detection engine 151 may reduce, for each animation type, a number of visual enhancement annotations associated with a respective animation type according to the per animation type limit by removing, after the per animation type limit of a respective animation type, any additional visual enhancement annotations associated with the respective animation type, and/or any other suitable method for reducing the list of visual enhancement annotations based on the per animation type limit.

In yet another example, an annotation criterion such as, a per time window limit can be a numerical value which indicates a number of visual enhancements within a predefined sliding time window. The predefined sliding time window may be a numerical value indicating a sliding time span. Accordingly, cue detection engine 151 can modify the list of visual enhancement annotations by reducing, for each time frame covered by the predefined sliding time window as it slides across a length of the media item, a number of visual enhancement annotations within a respective time frame according to the per time window limit. In particular, the length of the media item may be defined by a last timestamp in a transcript of the media item or alternatively, by difference between a last visual enhancement annotation of the list of visual enhancement annotations and a first visual enhancement annotation of the list of visual enhancement annotations. Thus, cue detection engine 151 may reduce, for each time frame, a number of visual enhancement annotations within a respective time frame according to the per time window limit by removing, after the per time window limit, any additional visual enhancement annotations within the respective time frame, and/or any other suitable method for reducing the list of visual enhancement annotations based on the per time window limit.

In still another example, an annotation criterion such as, a per user limit can be a numerical value which indicates a number of visual enhancements for each user. In some embodiments, cue detection engine 151 may maintain, for each user, a current per user amount which is a numerical value indicating a number of previous visual enhancements for a respective user. Accordingly, cue detection engine 151 can modify the list of visual enhancement annotations based on determining if a number of visual enhancement annotations in the list of visual enhancement annotations plus the current per user amount exceeds the per user limit. If the number of visual enhancement annotations in the list of visual enhancement annotations plus the current per user amount exceeds the per user limit, cue detection engine 151 may reduce, by a difference between (i) the number of visual enhancement annotations in the list of visual enhancement annotations plus the current per user amount and (ii) the per user limit, the number of visual enhancement annotations in the list of visual enhancement annotations. Cue detection engine 151 may reduce the number of visual enhancement by removing the difference from an end of the list of visual enhancement annotations, randomly from list of visual enhancement annotations, and/or any other suitable method for reducing the list of visual enhancement annotations by the difference to meet to the per user limit. Otherwise, cue detection engine 151 may not modify the list of visual enhancement annotations.

In yet another example, an annotation criterion such as, a per channel limit can be a numerical value which indicates a number of visual enhancements for a channel. Similar to the description with respect to the per user limit, cue detection engine 151 may maintain, for each channel, a current amount indicating a number of previous visual enhancements for a respective channel. Accordingly, cue detection engine 151 can modify the list of visual enhancement annotations based on determining whether a number of visual enhancement annotations in the list of visual enhancement annotations plus the current per channel amount exceeds the per channel limit. If the number of visual enhancement annotations in the list of visual enhancement annotations plus the current per user amount exceeds the per user limit, cue detection engine 151 may reduce, by a difference between (i) the number of visual enhancement annotations in the list of visual enhancement annotations plus the current per user amount and (ii) the per user limit, the number of visual enhancement annotations in the list of visual enhancement annotations. Cue detection engine 151 may reduce the number of visual enhancement by removing the difference from an end of the list of visual enhancement annotations, randomly from list of visual enhancement annotations, and/or any other suitable method for reducing the list of visual enhancement annotations by the difference to meet to the per user limit. Otherwise, cue detection engine 151 may not modify the list of visual enhancement annotations.

During modification of the list of visual enhancement annotations based on one or more annotation criteria, cue detection engine 151 may prioritize the selection of certain visual enhancement annotations of the list of visual enhancement annotations over others based on an order of priority assigned to the animation types. The order of priority assigned to the animation types, for example, from highest priority to lowest priority, may be a subscribe button animation type, a description section animation type, a comment section animation type, a like button animation type, a share button animation type, and a join button animation type.

Depending on the embodiment, cue detection engine 151 may generate one or more groups from the list of visual enhancement annotations (e.g., a list of groupings). Each grouping of the list of groupings may include a panel identifier identifying a panel of the UI of the platform 120. Each panel may include one or more UI elements (e.g., the one or more UI elements are located in a common section (or panel) of the UI of the platform 120). Accordingly, cue detection engine 151, for each panel of the UI of the platform 120, can identify which visual enhancement annotations in the list of visual enhancement annotations correspond to a UI element located in a respective panel. The identified visual enhancement annotations can be included in a grouping associated with the respective panel. The grouping associated with the respective panel may be assigned a timestamp of a visual enhancement annotation of the identified visual enhancement annotations. The timestamp of a visual enhancement annotation assigned to the grouping may be selected randomly, based on the order of priority, an earliest timestamp, or a latest timestamp.

Cue detection engine 151 may include, for each visual enhancement annotation in the list of visual enhancement annotations (or grouping of the list of groupings), a visual enhancement setting that instructs the UI of platform 120 on how to visually enhance portions of the UI (e.g., UI element or panel). Visual enhancement setting may define, for example, a duration of the visual enhancement, a thickness of a border, a color, opacity of the color, border, fill, border+fill, or any other setting associated with a visual enhancement of a UI element. Cue detection engine 151 may assign to each animation type (or panel identifier) a corresponding visual enhancement setting. As such, cue detection engine 151 can obtain, from a respective visual enhancement annotation, an animation type. Depending on the embodiment, cue detection engine 151 can also or alternatively obtain, from a respective grouping, a panel identifier. Cue detection engine 151 can determine, based on the animation type associated with the respective visual enhancement annotation (and/or panel identifier associated with a respective grouping), a corresponding visual enhancement setting and assign the corresponding visual enhancement setting to the respective visual enhancement annotation (or the respective grouping).

Cue detection engine 151, during playback of the media item of the media items 121, can maintain a current progression of the media item (e.g., a current point in time). Cue detection engine 151 can determine whether the current time matches a timestamp of a visual enhancement annotation of the list of visual enhancement annotations (e.g., matching visual enhancement annotation) or a timestamp of a grouping of the list of groupings (e.g., matching group).

In response to determining that the current time matches a timestamp of the matching visual enhancement annotation or a timestamp of the matching group, cue detection engine 151 may determine whether a visual enhancement based on a visual enhancement setting of the matching visual enhancement annotation (or matching group) may be triggered. In some embodiments, cue detection engine 151 may determine an orientation of the content viewer and/or the UI associated with the content viewer provided to the client device by platform 120. Orientation may be, for example, a portrait orientation or a landscape orientation. If the orientation is a portrait orientation, cue detection engine 151 may determine that the visual enhancement may be triggered. Otherwise, cue detection engine 151 may determine that the visual enhancement may not be triggered.

In some embodiments, cue detection engine 151 may determine a playback state of the media item of the media items 121. Playback state may indicate whether the media item of media items 121A-Z is in a play state, a pause state, or an advertisement state. If the playback state is a play state, cue detection engine 151 may determine that the visual enhancement may be triggered. Otherwise, cue detection engine 151 may determine that the visual enhancement may not be triggered.

In some embodiments, cue detection engine 151 may determine a UI element state of a UI element of the UI of the platform 120 associated with an animation type of the matching visual enhancement annotation (or located in a panel identified by a panel identifier of the matching group). UI element state may indicate whether the UI element has been previously selected or engaged (e.g., enabled) or not (e.g., disabled). If the UI element state of the UI element of the UI of the platform 120 associated with the animation type of the matching visual enhancement annotation (or located in a panel identified by a panel identifier of the matching group) is disabled, cue detection engine 151 may determine that the visual enhancement may be triggered. Otherwise, cue detection engine 151 may determine that the visual enhancement may not be triggered.

Cue detection engine 151 can trigger, based on determining that the visual enhancement may be triggered, the visual enhancement. Cue detection engine 151 may perform, using various animation techniques and/or methods, the visual enhancement based on the visual enhancement setting. The various animation techniques and/or methods may include, for example, displaying the visual enhancement as a Lottie in a component associated with the UI element (or panel) or relying on CSS animations/gradients to animate various aspects of the UI element (or panel) (e.g., background and/or border) based on the visual enhancement setting.

Depending on the embodiment, the media item may be a live media item rather than a recorded media item previously recorded and/or stored. For a live media item, there would be an entry in the media metadata data structure 115. Rather, in some embodiments, a transcript and/or a collection of thumbnails can be generated during streaming of the live media item. Similar to the above, a visual enhancement flag may be included during a request to initiate streaming of the live media item. If the visual enhancement flag is cleared, no further action is taken, and the live media item is streamed without visual enhancements. Otherwise, if the visual enhancement flag is set, cue detection engine 151 may analyze the transcript and/or the collection of thumbnails as they are being generated to determine whether the newly generated portion of the transcript and/or the collection of thumbnails contains any cue from a set of cues of any of the animation type. For example, cue detection engine 151 can determine whether the newly generated portion of the transcript and/or the collection of thumbnails (or previously generated portions in conjunction with the newly generated portion) matches any cue from a set of cues of any of the animation type (e.g., a matching cue). Cue detection engine 151 can determine, based on an animation type associated with the matching cue, a visual enhancement setting associated with the animation type.

Similar to the above, cue detection engine 151 may determine whether a visual enhancement for the live media item may be triggered based on a visual enhancement setting of the matching cue. Cue detection engine 151, based on determining that the visual enhancement may be triggered, can trigger the visual enhancement. Cue detection engine 151 may perform the visual enhancement based on the visual enhancement setting. In some embodiment, cue detection engine 151 performs the visual enhancement based on the visual enhancement setting by utilizing a file containing vector and animation data (e.g., Lottie assets) that renders After Effects animations (i.e., animations created using After Effects) in real-time according to the visual enhancement settings to enhance a UI element (or panel) of the UI of the platform 120 visually. In some embodiments, multiple containers for the UI element (or panel) may be created that vary the visual enhancement settings and subsequently show and hide them to enhance the UI element (or panel) of the UI of the platform 120 visually. In some embodiments, cascading style sheets (CSS) animations and/or gradients may be used to modify the background and/or border based on the visual enhancement settings to enhance the UI element (or panel) of the UI of the platform 120 visually.

Depending on the implementation, cue detection engine 151 or any of its components can be part of platform 120, can reside on one or more server machines that are remote from platform 120 (e.g., server machine 150), or can reside on client devices 102A-102N. It should be noted that in some other implementations, the functions of server machines 140, 150 and/or platform 120 can be provided by a fewer number of machines. For example, in some implementations, components and/or modules of any of server machines 140 and 150 can be integrated into a single machine, while in other implementations components and/or modules of any of server machines 140 and 150 can be integrated into multiple machines. In addition, in some implementations, components and/or modules of any of server machines 140 and 150 can be integrated into platform 120.

Although specific UI elements in terms of platform 120 are discussed, implementations can also be generally applied to any UI elements of platform 120. Although specific types of enhancements are discussed, other types of enhancements are considered, such as audio enhancements.

In general, functions described in implementations as being performed by platform 120 and/or any of server machines 140 and 150 can also be performed on the client devices 102A-N in other implementations. In addition, the functionality attributed to a particular component can be performed by different or multiple components operating together. Platform 120 can also be accessed as a service provided to other systems or devices through appropriate application programming interfaces, and thus is not limited to use in websites.

Although implementations of the disclosure are discussed in terms of platform 120 and users of platform 120 accessing a media item, implementations can also be generally applied to media items generally. Further, implementations of the disclosure are not limited to content sharing platforms that allow users to generate, share, view, and otherwise consume media items such as video items.

In implementations of the disclosure, a “user” can be represented as a single individual. However, other implementations of the disclosure encompass a “user” being an entity controlled by a set of users and/or an automated source. For example, a set of individual users federated as a community in a social network can be considered a “user.” In another example, an automated consumer can be an automated ingestion pipeline of platform 120.

In situations in which the systems discussed here collect personal information about users, or can make use of personal information, the users can be provided with an opportunity to control whether platform 120 collects user information (e.g., information about a user's social network, social actions or activities, profession, a user's preferences, or a user's current location), or to control whether and/or how to receive content from the content server that can be more relevant to the user. In addition, certain data can be treated in one or more ways before it is stored or used, so that personally identifiable information is removed. For example, a user's identity can be treated so that no personally identifiable information can be determined for the user, or a user's geographic location can be generalized where location information is obtained (such as to a city, ZIP code, or state level), so that a particular location of a user cannot be determined. Thus, the user can have control over how information is collected about the user and used by the platform 120.

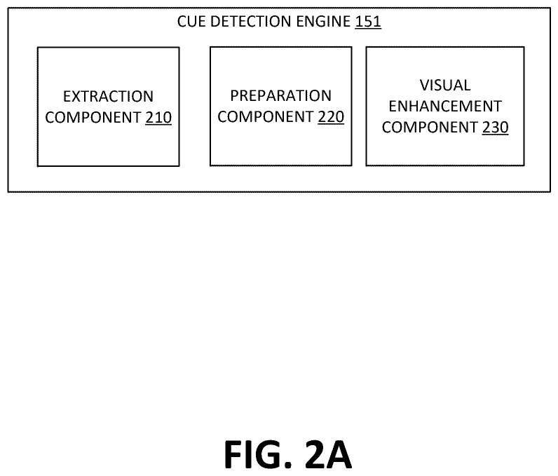

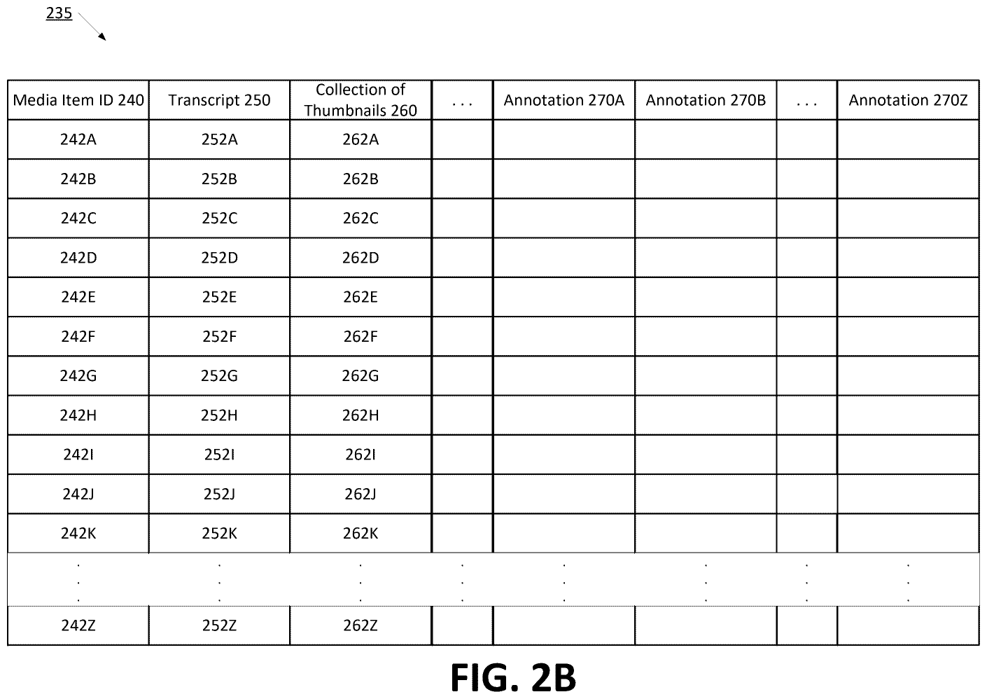

FIG. 2A is a block diagram illustrating an example cue detection engine 151, in accordance with implementations of the present disclosure. As described with respect to FIG. 1, cue detection engine 151 can during playback of a media item of media items 121A-Z automatically provide visual enhancements to UI elements of a UI of platform 120 in response to audio-visual cues. In an illustrative example, cue detection engine 151 can include an extraction component 210, a preparation component 220, and a visual enhancement component 230.

Extraction component 210 can determine multiple cues (e.g., auditory and/or visual cues) that may possibly correspond to a UI element. In particular, extraction component 210 can receive one or more general terms (e.g., words or phrases) for each UI elements of the UI of platform 120 to be animated (e.g., a plurality of UI elements) in response to a cue. Each UI element of the plurality of UI elements may correspond to an animation type (e.g., each UI element of the plurality of UI elements corresponds to an animation type of a plurality of animation types). Extraction component 210 can generate, based on a plurality of sample media items and the one or more general terms for a UI element, a set of cues to assign to a respective animation type of the plurality of animation types. As noted above, the set of cues assigned to the set cues may include a set of possible auditory cues and/or a set of possible visual cues. Each possible auditory cue of the set of possible auditory cues may be a phrase that includes the one or more general term (or a portion of the one or more general term) with a predetermined number of words before and/or after. Each possible visual cue of the set of possible visual cues may be a thumbnail from a collection of thumbnails that matches the one or more general terms. Extraction component 210 may assign each cue of the set of cues a quality score (between “0” and “1”) which dictates how contextually similar a respective cue is to a context of the respective animation type. Cue detection engine 151 may reduce, based on the quality score assigned to each cue of the set of cues satisfying the predetermined quality score threshold value, the set of cues.

Preparation component 220 can identify an occurrence of one or more cues of the multiple cues that may possibly correspond to a UI element in metadata (e.g., a transcript and/or collection of thumbnails) of each media item using a media metadata data structure 115. As noted above, the media metadata data structure 115 may include a plurality of entries. Each entry corresponds to a media item of media items 121A-Z and includes a media item identifier (e.g., media item ID). Each entry may include, among other things, a transcription of a respective media item and a collection of thumbnails. For each entry of the media metadata data structure 115, preparation component 220 can access a transcription and/or a collection of thumbnails of the media item. For each animation type of the plurality of animation type, preparation component 220 can traverse through the transcription to determine whether a cue of a set of cues assigned to a respective animation type is present. Additionally, and/or alternatively, preparation component 220 can traverse through the collection of thumbnails to determine whether a cue of a set of cues assigned to a respective animation type is present. For each occurrence of a cue of the set of cues in the transcript and/or the collection of thumbnails, preparation component 220 can create a visual enhancement annotation including a timestamp of a respective occurrence, the cue of the set of cues of the respective occurrence, a respective animation type corresponding to the cue of the set of cue, and a quality score of the cue of the set of cues. Preparation component 220 can append (or stores) the visual enhancement annotation at the end of the entry.

Preparation component 220 may periodically generate one or more visual enhancement annotation for each entry of the media metadata data structure 115 at predetermined time periods (e.g., hourly, daily, weekly, monthly, etc.). Based on the periodic predetermined time periods, the one or more visual enhancement annotation may have an expected staleness causing an expected delay (or latency) in obtaining one or more visual enhancement annotations for new entries associated with new media items of the media metadata data structure 115. Accordingly, the predetermined time periods may be adjusted to obtain an acceptable delay (or latency) for new entries.

In some implementations, the extraction component 210 and the preparation component 220 can collectively generate visual enhancement annotations for a media item and append (or store) the visual enhancement annotations at the end of the entry in the media metadata data structure 115 for the media item. Each visual enhancement annotation of the plurality of visual enhancement annotations may identify, among other things, a respective audio-visual cue, a timestamp associated with an occurrence of the respective audio-visual cue within the media item, and a UI element associated with the respective audio-visual cue.

Visual enhancement component 230 can identify, for a specific media item, each occurrence of the one or more cues of the multiple cues in the specific media item and visually enhances a corresponding UI element or portion of the platform when a current time of the media item matches a time of a respective occurrence of the one or more cues of the multiple cues in the media metadata data structure 115. In some embodiments, visual enhancement component 230 receives (or identifies) a request (e.g., a playback request) to play a media item of media items 121, identified using a media item ID associated with the media item, on a content viewer of client devices 102A-N. In some embodiments, the playback request includes a visual enhancement flag indicating whether visual enhancement feature is enabled or disabled. If the visual enhancement flag is enabled, visual enhancement component 230 can retrieve each visual enhancement annotation from an entry of the media metadata data structure 115 identified by the media item ID. Visual enhancement component 230 includes each visual enhancement annotation of the entry in a list of visual enhancement annotations. As such, visual enhancement component 230, based on each visual enhancement annotation of the entry, can identify a list of visual enhancement annotations for the media item.

Visual enhancement component 230 may modify the list of visual enhancement annotations based on one or more annotation criteria (e.g., highest quality score per animation type, distraction per media item limit, per media item limit, per animation type limit, per time window limit, per user limit, or per channel limit). Additionally, visual enhancement component 230, during modification, may prioritize certain visual enhancement annotation over others based on an order of priority (e.g., from highest priority to lowest priority, a subscribe button animation type, a description section animation type, a comment section animation type, a like button animation type, a share button animation type, and a join button animation type). Additionally, and/or alternatively, visual enhancement component 230 may identify one or more groups from the list of visual enhancement annotations based on a location of their UI elements in a panel of a plurality of panels of the UI of the platform.

Visual enhancement component 230 can identify, for each visual enhancement annotation of the list of visual enhancement annotation, a visual enhancement setting. If the list of visual enhancement annotations are grouped into one or more groups, visual enhancement component 230 can identify, for each group of the one or more group, a visual enhancement setting. As noted above, a visual enhancement setting can instruct the UI of platform 120 how to visually enhance portions of the UI (e.g., UI element or panel). Visual enhancement setting can define a duration of the visual enhancement, a thickness of a border, a color, opacity of the color, border, fill, border+fill, etc. Each animation type and group (referenced by panel identifier) can be assigned a corresponding visual enhancement setting.

Visual enhancement component 230, during playback of the media item of the media items 121, can determine whether a current time of the media item playback matches a timestamp of a visual enhancement annotation of the list of visual enhancement annotations (or a timestamp of a grouping of the list of groupings).

Depending on the embodiment, the media item may be live rather than recorded. Visual enhancement component 230 can determine from a transcript and/or a collection of thumbnails of the live media item being generated on the fly (e.g., during streaming of the live media item) whether a newly generated portion (and/or a previously generated portion) of the transcript and/or the collection of thumbnails matches any cue from a set of cues of any of the animation type. Visual enhancement component 230 may generate a visual enhancement annotation based on the cue matching the newly generated portion (and/or a previously generated portion) and assign a corresponding visual enhancement setting based on an animation type of the cue.

If there is a match, visual enhancement component 230 can determine whether to trigger a visual enhancement based on a visual enhancement setting of the matching visual enhancement annotation (or matching group). For example, visual enhancement component 230 can determine whether to trigger a visual enhancement based on, for example, an orientation of the content viewer, orientation of the UI associated with the content viewer, playback state of the media item, UI element state, etc. Visual enhancement component 230 can trigger, based on determining that the visual enhancement may be triggered, the visual enhancement. Visual enhancement component 230 can perform, in response to triggering the visual enhancement, the visual enhancement based on the visual enhancement setting using various animation techniques (e.g., using Lottie and/or CSS animations/gradients).

FIG. 2B illustrates an example media metadata data structure 235, similar to media metadata data structure 115 of FIG. 1, in accordance with implementations of the present disclosure. As noted above, media metadata data structure 235 includes a plurality of rows and a plurality of columns. The plurality of rows corresponds to the plurality of entries. In particular, each row of the plurality of rows corresponds to an entry of the plurality of entries. The plurality of columns includes a media item ID column (e.g., media item ID 240), a transcript column (e.g., transcript 250), a collection of thumbnails column (e.g., collection of thumbnails 260), and among other columns, multiple visual enhancement annotations and/or grouping columns (e.g., annotations 270A-Z). It is noted that, the depicted visual enhancement annotations columns are provided for illustrative purposes only and can be reduced or expanded to accommodate as many or as few visual annotations and/or groupings needed for an entry.

Each entry of the media metadata data structure 235 (e.g., a row of the plurality of rows) identified by media item ID 240 (e.g., a column of the plurality of columns) (e.g., entry 242A-Z) can include metadata associated with transcript 250 (e.g., metadata 252A-Z) and metadata associated with collection of thumbnails 260 (e.g., metadata 262A-Z).

As noted above, preparation component 220 (of FIG. 2A) can periodically generate one or more visual enhancement annotations (or groupings) for each entry of the media metadata data structure 220 at predetermined time periods. For each entry of the media metadata data structure 235, preparation component 220 can access a transcription (e.g., metadata 252A) of an entry (e.g., entry 242A) and/or a collection of thumbnails (e.g., metadata 262A), and traverse, for each animation type of the plurality of animation type, through the transcription (e.g., metadata 252A) to determine whether a cue of a set of cues assigned to a respective animation type is present. Additionally, and/or alternatively, preparation component 220 can traverse through the collection of thumbnails (e.g., metadata 262A) to determine whether a cue of a set of cues assigned to a respective animation type is present. For each occurrence of a cue of the set of cues in the transcript and/or the collection of thumbnails, preparation component 220 can create a visual enhancement annotation including a timestamp of a respective occurrence, the cue of the set of cues of the respective occurrence, a respective animation type corresponding to the cue of the set of cue, and a quality score of the cue of the set of cues. Preparation component 220 can append (or store) the visual enhancement annotation at the end of the entry (e.g., annotation 270A of entry 242A).

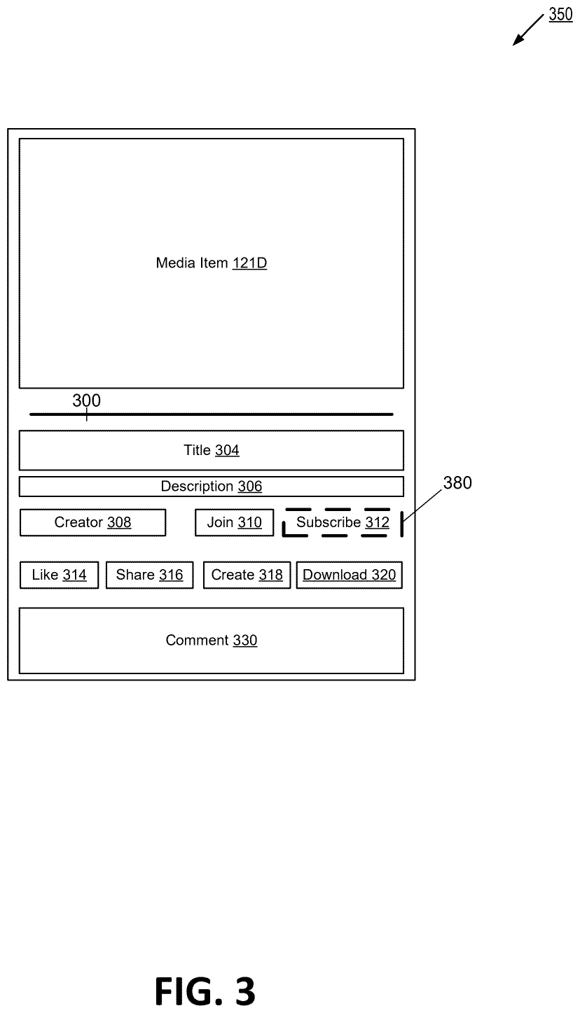

FIG. 3 illustrates an example UI 350 of a platform, similar to platform 120 of FIG. 1, at a current time (e.g., current time 300) within played media item (e.g., media item 121D) in which the cue detection engine automatically enhances a UI element of the UI, in accordance with implementations of the present disclosure.

A UI of platform 120 may include a progress UI element (e.g., progress bar 302), a title UI element (e.g., title 304), a description UI element (e.g., description 306), a creator UI element (e.g., creator 308), a join UI element (e.g., join 310), a subscribe UI element (e.g., subscribe 312), a like UI element (e.g., like 314), a share UI element (e.g., share 316), a create UI element (e.g., create 318), a download UI element (e.g., download 320), and a comment UI element (e.g., comment 330).

Progress bar 302 provides a current progress of a playback of a media item (e.g., current time). Title 304 provides the title of the media item. Description 306 provides information about the media item and/or related information to the media item. Creator 308 provides information about the content creator of the media item. Join 310 when engaged by the user allows the user to join (e.g., for a fee) a channel associated with the media item. Subscribe 312 when engaged by the user allows the user to subscribe or join (e.g., for free) the channel associated with the media item. Like 314 when engaged by the user allows the user to like (or approve) of the media item. Share 316 when engaged by the user allows the user to share the media item with another user. Create 318 when engaged by the user allows the user to create a new media item from the media item. Download 320 when engaged by the user allows the user to download the media item to the user device. Comment 330 when engaged by the user allows the user to write or share a comment related to the media item.

Cue detection engine (e.g., cue detection engine 151 of FIG. 1) can identify a playback request received by the platform 120 from a user. Playback request may identify a media item (e.g., media item 121D) via a media item ID. Cue detection engine can determine whether the playback request includes a set visual enhancement flag (e.g., visual enhancement feature is enabled). In response to determining that the playback request includes a set visual enhancement flag, cue detection engine can retrieve a list of visual enhancement annotations from a media metadata storage (e.g., media metadata data structure 115 of FIG. 1) using a media item ID. Cue detection engine may modify and/or reduce the list of visual enhancement annotations based one or more annotation criteria.

During playback of the media item 121D, cue detection engine can determine, for each current time obtained from progress bar 302, whether a timestamp of each visual enhancement annotation of the list of visual enhancement annotations matches a respective current time. Cue detection engine may determine that a current time 300 obtained from progress bar 302 matches a timestamp of a visual enhancement annotation of the list of visual enhancement annotations (e.g., a matching visual enhancement annotation). An animation type of the matching visual enhancement annotation may be a subscribe button animation type from a subscribe UI element (e.g., subscribe 312). Cue detection engine may determine that a visual enhancement 380 (e.g., changing the color of the border around subscribe 312) dictated by the visual enhancement setting of the matching visual enhancement annotation may be triggered. Cue detection engine can trigger the visual enhancement by performing the visual enhancement 380 in view of a visual enhancement setting of the matching visual enhancement annotation using various animation techniques (e.g., using Lottie and/or CSS animations/gradients). Cue detection engine can continue to monitor, for each subsequent point in time presented via progress bar 302, whether a timestamp of another visual enhancement annotation of the list of visual enhancement annotations is a match and further perform visual enhancement associated with another visual enhancement annotation until an end of the media item 121D is reached.

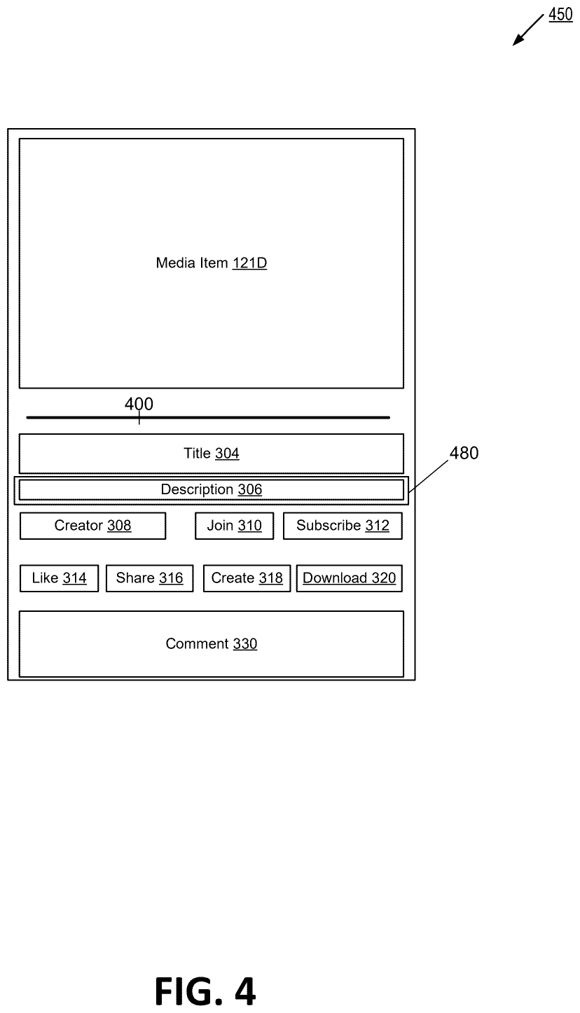

FIG. 4 illustrates an example UI 450 of a platform, similar to platform 120 of FIG. 1, at a current time (e.g., current time 400) within played media item (e.g., media item 121D) in which the cue detection engine automatically enhances a UI element of the UI, in accordance with implementations of the present disclosure.

After a previous visual enhancement (e.g., visual enhancement 380 of FIG. 3) and during continued playback of the media item 121D, cue detection engine can determine, for each current time obtained from progress bar 302, whether a timestamp of each visual enhancement annotation of the list of visual enhancement annotations matches a respective current time. Cue detection engine may determine that a current time 400 obtained from progress bar 302 matches a timestamp of a visual enhancement annotation of the list of visual enhancement annotations (e.g., a matching visual enhancement annotation). An animation type of the matching visual enhancement annotation may be a description section animation type from a description UI element (e.g., description 306). Cue detection engine may determine that a visual enhancement 480 (e.g., visually encapsulating, or highlighting description 306, giving the appearance of a “bubble”) dictated by the visual enhancement setting of the matching visual enhancement annotation may be triggered. Cue detection engine can trigger the visual enhancement by performing the visual enhancement 480 in view of a visual enhancement setting of the matching visual enhancement annotation using various animation techniques (e.g., using Lottie and/or CSS animations/gradients). Cue detection engine can continue to monitor, for each subsequent time obtained from progress bar 302, whether a timestamp of another visual enhancement annotation of the list of visual enhancement annotations is a match and further perform visual enhancement associated with another visual enhancement annotation until an end of the media item 121D is reached.

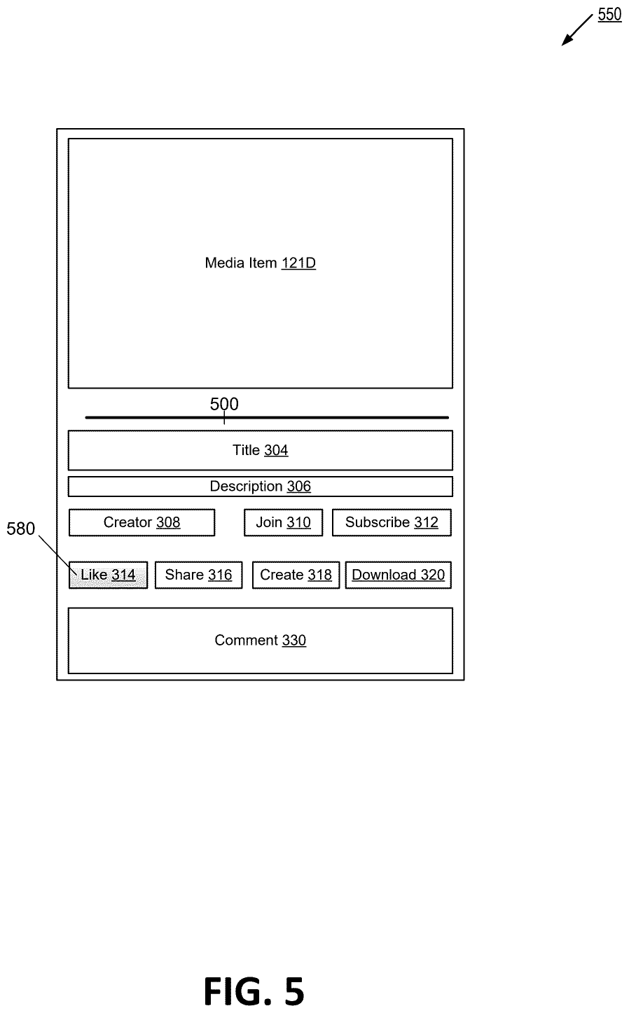

FIG. 5 illustrates an example UI 550 of a platform, similar to platform 120 of FIG. 1, at a current time (e.g., current time 500) within played media item (e.g., media item 121D) in which the cue detection engine automatically enhances a UI element of the UI, in accordance with implementations of the present disclosure.

After a previous visual enhancement (e.g., visual enhancement 480 of FIG. 4) and during continued playback of the media item 121D, cue detection engine can determine, for each current time obtained from progress bar 302, whether a timestamp of each visual enhancement annotation of the list of visual enhancement annotations matches a respective current time. Cue detection engine may determine that a current time 500 obtained from progress bar 302 matches a timestamp of a visual enhancement annotation of the list of visual enhancement annotations (e.g., a matching visual enhancement annotation). An animation type of the matching visual enhancement annotation may be a like button animation type from a like UI element (e.g., like 314). Cue detection engine may determine that a visual enhancement 580 (e.g., changing the color of like 514) dictated by the visual enhancement setting of the matching visual enhancement annotation may be triggered. Cue detection engine can trigger the visual enhancement by performing the visual enhancement 580 in view of a visual enhancement setting of the matching visual enhancement annotation using various animation techniques (e.g., using Lottie and/or CSS animations/gradients). Cue detection engine can continue to monitor, for each subsequent time obtained from progress bar 302, whether a timestamp of another visual enhancement annotation of the list of visual enhancement annotations is a match and further perform visual enhancement associated with another visual enhancement annotation until an end of the media item 121D is reached.

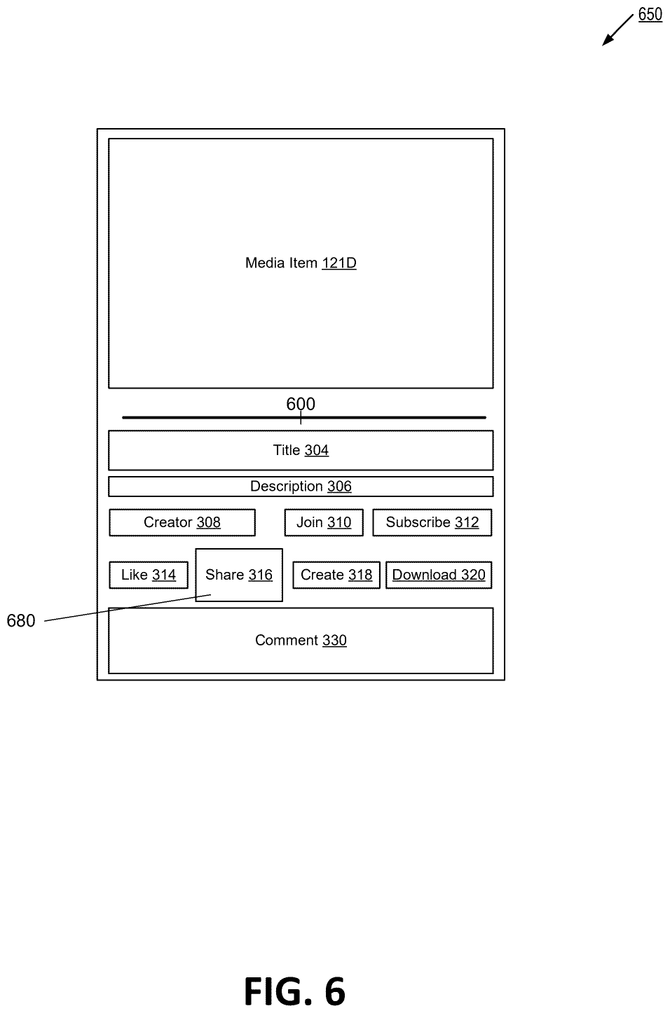

FIG. 6 illustrates an example UI 650 of a platform, similar to platform 120 of FIG. 1, at a current time (e.g., current time 600) within played media item (e.g., media item 121D) in which the cue detection engine automatically enhances a UI element of the UI, in accordance with implementations of the present disclosure.

After a previous visual enhancement (e.g., visual enhancement 580 of FIG. 5) and during continued playback of the media item 121D, cue detection engine can determine, for each current time obtained from progress bar 302, whether a timestamp of each visual enhancement annotation of the list of visual enhancement annotations matches a respective current time. Cue detection engine may determine that a current time 600 obtained from progress bar 302 matches a timestamp of a visual enhancement annotation of the list of visual enhancement annotations (e.g., a matching visual enhancement annotation). An animation type of the matching visual enhancement annotation may be a share button animation type from a share UI element (e.g., share 316). Cue detection engine may determine that a visual enhancement 680 (e.g., changing the size of share 316) dictated by the visual enhancement setting of the matching visual enhancement annotation may be triggered. Cue detection engine can trigger the visual enhancement by performing the visual enhancement 680 in view of a visual enhancement setting of the matching visual enhancement annotation using various animation techniques (e.g., using Lottie and/or CSS animations/gradients). Cue detection engine can continue to monitor, for each subsequent time obtained from progress bar 302, whether a timestamp of another visual enhancement annotation of the list of visual enhancement annotations is a match and further perform visual enhancement associated with another visual enhancement annotation until an end of the media item 121D is reached.

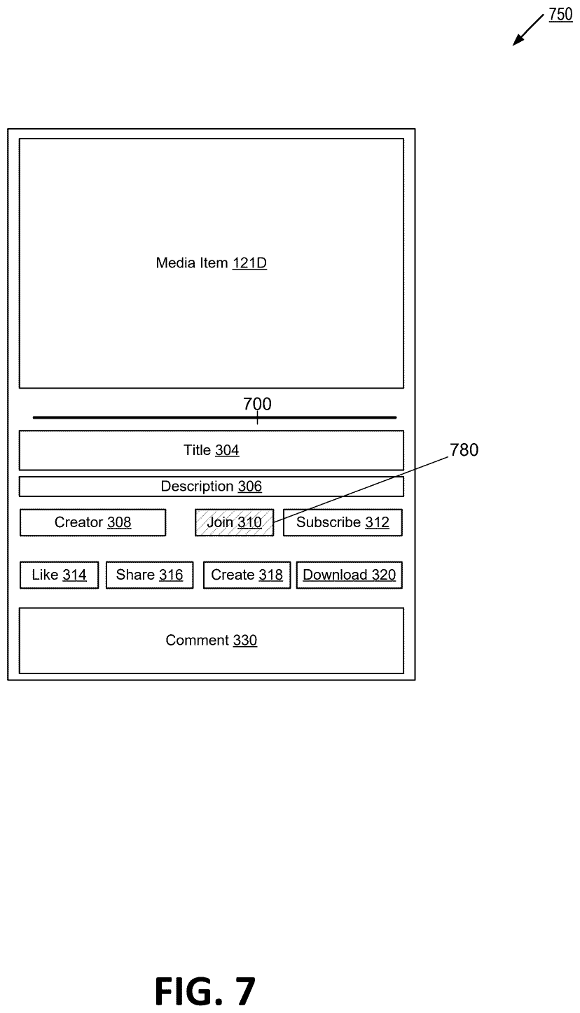

FIG. 7 illustrates an example UI 750 of a platform, similar to platform 120 of FIG. 1, at a current time (e.g., current time 700) within played media item (e.g., media item 121D) in which the cue detection engine automatically enhances a UI element of the UI, in accordance with implementations of the present disclosure.

After a previous visual enhancement (e.g., visual enhancement 680 of FIG. 6) and during continued playback of the media item 121D, cue detection engine can determine, for each current time obtained from progress bar 302, whether a timestamp of each visual enhancement annotation of the list of visual enhancement annotations matches a respective current time. Cue detection engine may determine that a current time 700 obtained from progress bar 302 matches a timestamp of a visual enhancement annotation of the list of visual enhancement annotations (e.g., a matching visual enhancement annotation). An animation type of the matching visual enhancement annotation may be a join button animation type from a join UI element (e.g., join 310). Cue detection engine may determine that a visual enhancement 780 (e.g., changing the color of join 310) dictated by the visual enhancement setting of the matching visual enhancement annotation may be triggered. Cue detection engine can trigger the visual enhancement by performing the visual enhancement 780 in view of a visual enhancement setting of the matching visual enhancement annotation using various animation techniques (e.g., using Lottie and/or CSS animations/gradients). Cue detection engine can continue to monitor, for each subsequent time obtained from progress bar 302, whether a timestamp of another visual enhancement annotation of the list of visual enhancement annotations is a match and further perform visual enhancement associated with another visual enhancement annotation until an end of the media item 121D is reached.

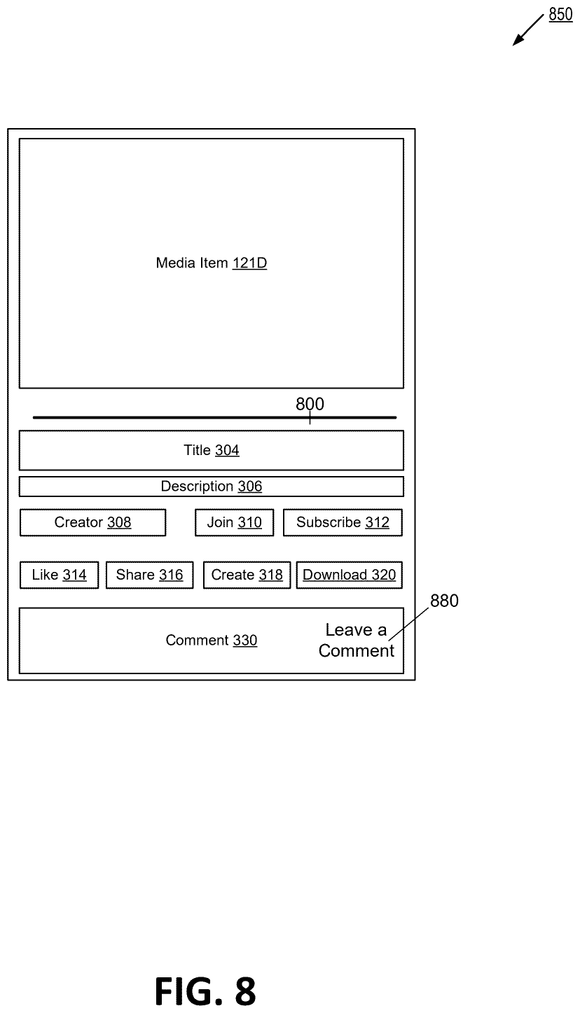

FIG. 8 illustrates an example UI 850 of a platform, at a current time (e.g., current time 800) within played media item (e.g., media item 121D) in which the cue detection engine automatically enhances a UI element of the UI, in accordance with implementations of the present disclosure.

After a previous visual enhancement (e.g., visual enhancement 680 of FIG. 6) and during continued playback of the media item 121D, cue detection engine can determine, for each current time obtained from progress bar 302, whether a timestamp of each visual enhancement annotation of the list of visual enhancement annotations matches a respective current time. Cue detection engine may determine that a current time 800 obtained from progress bar 302 matches a timestamp of a visual enhancement annotation of the list of visual enhancement annotations (e.g., a matching visual enhancement annotation). An animation type of the matching visual enhancement annotation may be a comment section animation type from a comment UI element (e.g., comment 330). Cue detection engine may determine that a visual enhancement 880 (e.g., adding a message next to comment 330) dictated by the visual enhancement setting of the matching visual enhancement annotation may be triggered. Cue detection engine can trigger the visual enhancement by performing the visual enhancement 880 in view of a visual enhancement setting of the matching visual enhancement annotation using various animation techniques (e.g., using Lottie and/or CSS animations/gradients). Cue detection engine can continue to monitor, for each subsequent time obtained from progress bar 302, whether a timestamp of another visual enhancement annotation of the list of visual enhancement annotations is a match and further perform visual enhancement associated with another visual enhancement annotation until an end of the media item 121D is reached.

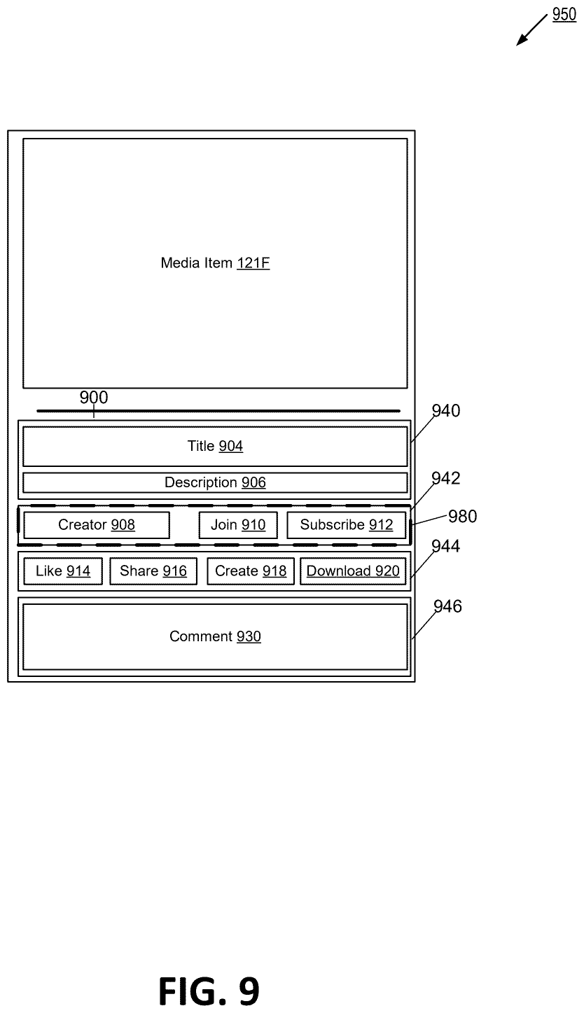

FIG. 9 illustrates an example UI 950 of a platform, at a current time (e.g., current time 900) within played media item (e.g., media item 121F) in which the cue detection engine automatically enhances a portion of the UI, in accordance with implementations of the present disclosure.

UI 950, similar to UI 350 of FIG. 3, may include a progress UI element (e.g., progress bar 902), a title UI element (e.g., title 904), a description UI element (e.g., description 906), a creator UI element (e.g., creator 908), a join UI element (e.g., join 910), a subscribe UI element (e.g., subscribe 912), a like UI element (e.g., like 914), a share UI element (e.g., share 916), a create UI element (e.g., create 918), a download UI element (e.g., download 920), and a comment UI element (e.g., comment 930).

UI 950 may be divided into multiple panels (e.g., a first panel 940, a second panel 942, a third panel 944, a fourth panel 946). The multiple panels may not be readily visible to the user. First panel 940 may include title 904 and description 906. Second panel 942 may include creator 908, join 910, and subscribe 912. Third panel 944 may include like 914, share 916, create 918, and download 920. Fourth panel 946 may include comment 930.

Cue detection engine (e.g., cue detection engine 151 of FIG. 1) can identify a playback request received by the platform 120 from a user. Playback request may identify a media item (e.g., media item 121F) via a media item ID. Cue detection engine can determine whether the playback request includes a set visual enhancement flag (e.g., visual enhancement feature is enabled). In response to determining that the playback request includes a set visual enhancement flag, cue detection engine can retrieve a list of groupings from a media metadata storage (e.g., media metadata data structure 115 of FIG. 1) using a media item ID. Cue detection engine may modify and/or reduce the list of groupings based one or more annotation criteria.

During playback of the media item 121F, cue detection engine can determine, for each current time obtained from progress bar 302, whether a timestamp of each grouping of the list of groupings matches a respective current time. Cue detection engine may determine that a current time 900 obtained from progress bar 302 matches a timestamp of a grouping of the list of groupings (e.g., a matching grouping). A panel identifier of the matching grouping may identify a second panel 942. Cue detection engine may determine that a visual enhancement 980 (e.g., introducing a border around second panel 942) dictated by the visual enhancement setting of the matching grouping may be triggered. Cue detection engine can trigger the visual enhancement by performing the visual enhancement 980 in view of a visual enhancement setting of the matching grouping using various animation techniques (e.g., using Lottie and/or CSS animations/gradients). Cue detection engine can continue to monitor, for each subsequent time obtained from progress bar 902, whether a timestamp of another grouping of the list of groupings is a match and further perform visual enhancement associated with another grouping until an end of the media item 121F is reached.

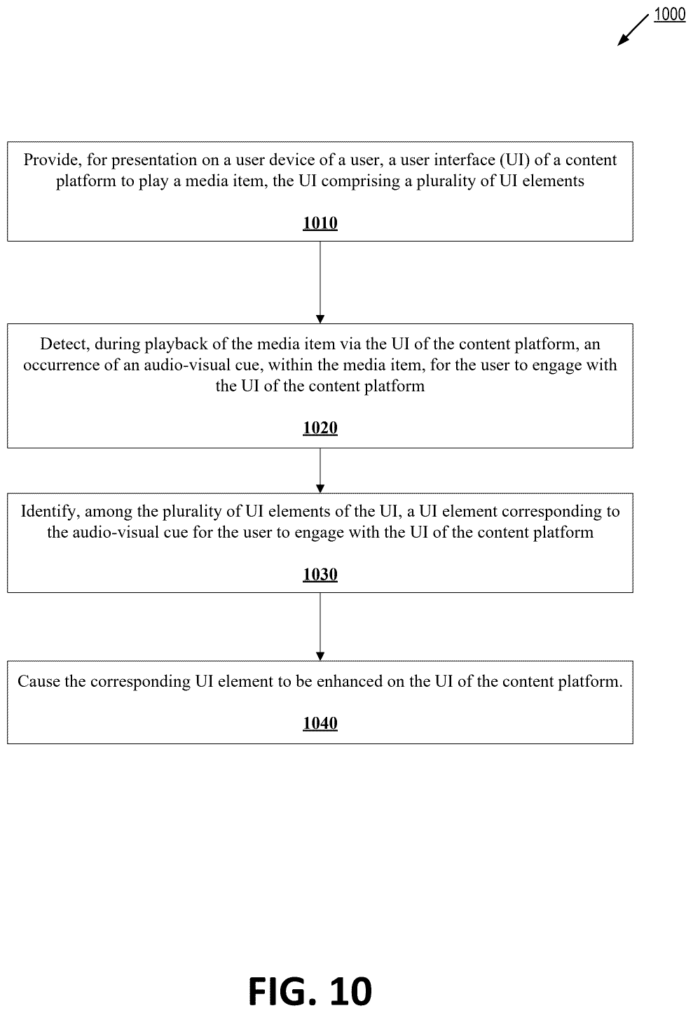

FIG. 10 depicts a flow diagram of an example method 1000 for automatically enhancing UI elements of a content platform in response to an audio-visual cue, in accordance with implementations of the present disclosure. Method 1000 can be performed by processing logic that can include hardware (circuitry, dedicated logic, etc.), software (e.g., instructions run on a processing device), or a combination thereof. In one implementation, some, or all of the operations of method 1000 can be performed by one or more components of system 100 of FIG. 1. In some embodiments, some, or all of the operations of method 1000 can be performed by cue detection engine 151, as described above.

At block 1010, processing logic provides, for presentation on a user device of a user, a user interface (UI) of a content platform (or platform) to play a media item, the UI comprising a plurality of UI elements. The UI elements may include, for example, a like button, a share button, a subscribe button, a join button, a comment section, or a description section.

At block 1020, during playback of the media item via the UI of the content platform, the processing logic detects an occurrence of an audio-visual cue, within the media item, for the user to engage with the UI of the content platform. In some implementations, the processing logic can access a media metadata data structure comprising a plurality of entries each associated with one of a plurality of media items. The processing logic can identify, using an entry associated with the media item in the media metadata data structure, a plurality of visual enhancement annotations associated with the media item. Each of the plurality of visual enhancement annotations can identify a respective audio-visual cue, a timestamp associated with an occurrence of the respective audio-visual cue within the media item, and a UI element associated with the respective audio-visual cue. The processing logic can select, at a first point in time during the playback of the media item, one of the plurality of visual enhancement annotations that has a timestamp matching the first point in time.

In some embodiments, each visual enhancement annotation may be generated from a timestamped transcript (or timestamped collection of thumbnails) of the media item. The processing logic can search (or traverse) a timestamped transcript (or timestamped collection of thumbnails) of the media item for each occurrence of an audio-visual cue (e.g., an auditory cue or visual cue) associated with each animation type (e.g., a UI element identifier). For each occurrence of the audio-visual cue associated with each animation type (e.g., a UI element), the processing logic can create a visual enhancement annotation of the plurality of visual enhancement annotations. For example, the processing logic can include in the visual enhancement annotation of the plurality of visual enhancement annotations a timestamp associated with the occurrence of the audio-visual cue (e.g., an auditory cue or visual cue) in the timestamped transcript (or timestamped collection of thumbnails), the audio-visual cue, the type, a quality score, etc.

At block 1030, the processing logic identifies, among the plurality of UI elements of the UI, a UI element corresponding to the audio-visual cue for the user to engage with the UI of the content platform. The selected visual enhancement annotation can specify an audio-visual cue and the UI element corresponding to the audio-visual cue.

At block 1040, the processing logic causes the corresponding UI element (e.g., a like button, a share button, a subscribe button, a join button, a comment section, a description section) to be enhanced on the UI of the content platform. The UI element can be enhanced on the UI of the content platform using a visual enhancement setting of the selected visual enhancement annotation which dictates how to enhance the corresponding UI element. The visual enhancement can include illuminating the corresponding UI element or pixels surrounding the corresponding UI element, animating the corresponding UI element, or adding a message next to the corresponding UI element.

Depending on the embodiment, the processing logic can detect one or more actions of the user. Prior to causing the corresponding UI element to be enhanced, the processing logic can verify that enhancing the corresponding UI element is consistent with the one or more actions of the user. For example, if the one or more actions of the user include liking the media item, the corresponding UI element is not enhanced. In other words, the user should not have already completed one or more actions in order for the corresponding UI to be enhanced.

Depending on the embodiment, the processing logic can ensure that the number of times the corresponding UI element is enhanced during the payback of the media item is below a threshold number. For example, enhancement can be performed if the number of visual enhancements of the platform does not exceed a predetermined number of visual enhancements assigned to the media item (e.g., threshold number). In another example, enhancement can be performed if the number of visual enhancements during playback of one or more video items from a channel does not exceed a predetermined number of visual enhancements of UI elements for the channel. In yet another example, enhancement can be performed if the number of visual enhancements of the UI element during playback of media items does not exceed a predetermined number of visual enhancements assigned to the UI element, etc.

Depending on the embodiment, the processing logic can determine whether a UI enhancement feature is enabled or disabled based on user input or capability of the user device. UI enhancement feature (e.g., visual enhancement flag) may be enabled by the user and disabled by the user, due to inability of the client device to handle UI enhancements, due to limited accessibility features of the client device, due to harmfulness of the media item or channel including the media item, due to particular audience (e.g., children), etc. Responsive to determining that the UI enhancement feature is enabled, the corresponding UI element can be enhanced on the UI of the content platform.

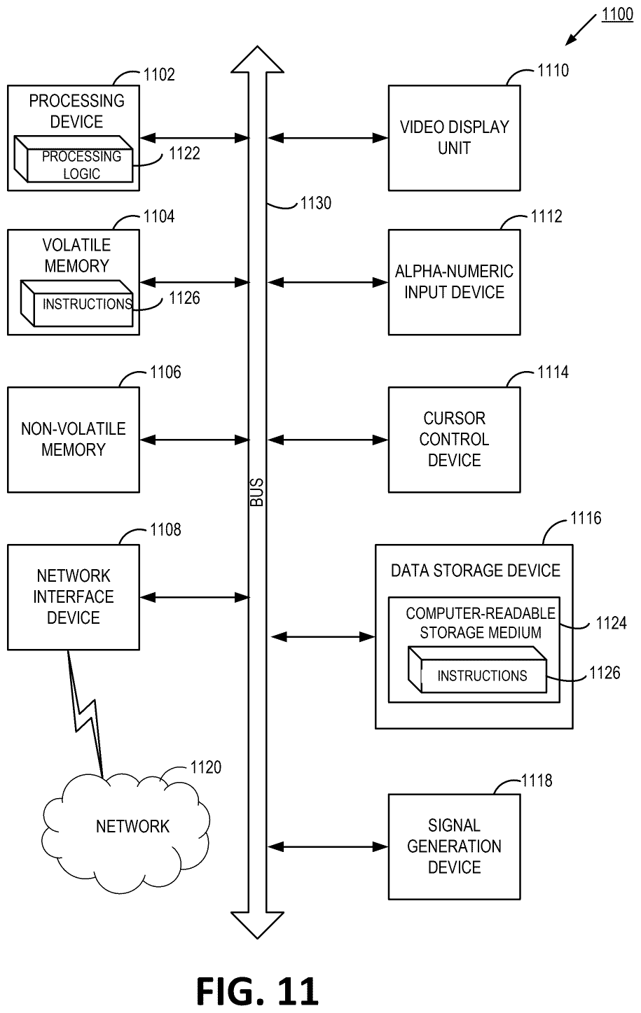

FIG. 11 is a block diagram illustrating an exemplary computer system 1100, in accordance with implementations of the present disclosure. The computer system 1100 can correspond to platform 120 and/or client devices 102A-N, described with respect to FIG. 1. Computer system 1100 can operate in the capacity of a server or an endpoint machine in endpoint-server network environment, or as a peer machine in a peer-to-peer (or distributed) network environment. The machine can be a television, a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1100 includes a processing device (processor) 1102, a main memory 1104 (e.g., read-only memory (ROM), flash memory, dynamic random access memory (DRAM) such as synchronous DRAM (SDRAM), double data rate (DDR SDRAM), or DRAM (RDRAM), etc.), a static memory 1106 (e.g., flash memory, static random access memory (SRAM), etc.), and a data storage device 1118, which communicate with each other via a bus 1140.

Processor (processing device) 1102 represents one or more general-purpose processing devices such as a microprocessor, central processing unit, or the like. More particularly, the processor 1102 can be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 1102 can also be one or more special-purpose processing devices such as an application specific integrated circuit (ASIC), a field programmable gate array (FPGA), a digital signal processor (DSP), network processor, or the like. The processor 1102 is configured to execute instructions 1105 (e.g., for automatically enhancing UI elements of a content platform in response to an audio-visual cue) for performing the operations discussed herein.

The computer system 1100 can further include a network interface device 1108. The computer system 1100 also can include a video display unit 1110 (e.g., a liquid crystal display (LCD) or a cathode ray tube (CRT)), an input device 1112 (e.g., a keyboard, and alphanumeric keyboard, a motion sensing input device, touch screen), a cursor control device 1114 (e.g., a mouse), and a signal generation device 1120 (e.g., a speaker).

The data storage device 1118 can include a non-transitory machine-readable storage medium 1124 (also computer-readable storage medium) on which is stored one or more sets of instructions 1105 (e.g., for automatically enhancing UI elements of a content platform in response to an audio-visual cue) embodying any one or more of the methodologies or functions described herein. The instructions can also reside, completely or at least partially, within the main memory 1104 and/or within the processor 1102 during execution thereof by the computer system 1100, the main memory 1104 and the processor 1102 also constituting machine-readable storage media. The instructions can further be transmitted or received over a network 1130 via the network interface device 1108.

In one implementation, the instructions 1105 include instructions for automatically enhancing UI elements of a content platform in response to an audio-visual cue. While the computer-readable storage medium 1124 (machine-readable storage medium) is shown in an exemplary implementation to be a single medium, the terms “computer-readable storage medium” and “machine-readable storage medium” should be taken to include a single medium or multiple media (e.g., a centralized or distributed database, and/or associated caches and servers) that store the one or more sets of instructions. The terms “computer-readable storage medium” and “machine-readable storage medium” shall also be taken to include any medium that is capable of storing, encoding, or carrying a set of instructions for execution by the machine and that cause the machine to perform any one or more of the methodologies of the present disclosure. The terms “computer-readable storage medium” and “machine-readable storage medium” shall accordingly be taken to include, but not be limited to, solid-state memories, optical media, and magnetic media.

Reference throughout this specification to “one implementation,” “one embodiment,” “an implementation,” or “an embodiment,” means that a particular feature, structure, or characteristic described in connection with the implementation and/or embodiment is included in at least one implementation and/or embodiment. Thus, the appearances of the phrase “in one implementation,” or “in an implementation,” in various places throughout this specification can, but are not necessarily, referring to the same implementation, depending on the circumstances. Furthermore, the particular features, structures, or characteristics can be combined in any suitable manner in one or more implementations.

To the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), software, a combination of hardware and software, or an entity related to an operational machine with one or more specific functionalities. For example, a component can be, but is not limited to being, a process running on a processor (e.g., digital signal processor), a processor, an object, an executable, a thread of execution, a program, and/or a computer. By way of illustration, both an application running on a controller and the controller can be a component. One or more components can reside within a process and/or thread of execution and a component can be localized on one computer and/or distributed between two or more computers. Further, a “device” can come in the form of specially designed hardware; generalized hardware made specialized by the execution of software thereon that enables hardware to perform specific functions (e.g., generating interest points and/or descriptors); software on a computer readable medium; or a combination thereof.

The aforementioned systems, circuits, modules, and so on have been described with respect to interact between several components and/or blocks. It can be appreciated that such systems, circuits, components, blocks, and so forth can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components can be combined into a single component providing aggregate functionality or divided into several separate sub-components, and any one or more middle layers, such as a management layer, can be provided to communicatively couple to such sub-components in order to provide integrated functionality. Any components described herein can also interact with one or more other components not specifically described herein but known by those of skill in the art.

Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “4 employs A or B” is intended to mean any of the natural inclusive permutations. That is, if 4 employs A; 4 employs B; or 4 employs both A and B, then “4 employs A or B” is satisfied under any of the foregoing instances. In addition, the articles “a” and “an” as used in this application and the appended claims should generally be construed to mean “one or more” unless specified otherwise or clear from context to be directed to a singular form.

Finally, implementations described herein include collection of data describing a user and/or activities of a user. In one implementation, such data is only collected upon the user providing consent to the collection of this data. In some implementations, a user is prompted to explicitly allow data collection. Further, the user can opt-in or opt-out of participating in such data collection activities. In one implementation, the collect data is anonymized prior to performing any analysis to obtain any statistical patterns so that the identity of the user cannot be determined from the collected data.

What is claimed is:

1. A method comprising:
providing, for presentation on a user device of a user, a user interface (UI) of a content platform to play a media item, the UI comprising a plurality of UI elements;
detecting, during playback of the media item via the UI of the content platform, an occurrence of an audio-visual cue, within the media item, for the user to engage with the UI of the content platform;
identifying, among the plurality of UI elements of the UI, a UI element corresponding to the audio-visual cue for the user to engage with the UI of the content platform; and
causing the corresponding UI element to be enhanced on the UI of the content platform.

2. The method of claim 1, wherein detecting the occurrence of the audio-visual cue within the media item further comprises:
accessing a media metadata data structure comprising a plurality of entries each associated with one of a plurality of media items;
identifying, using an entry associated with the media item in the media metadata data structure, a plurality of visual enhancement annotations each corresponding to one of a plurality of audio-visual cues; and
selecting, at a first point in time during the playback of the media item, one of the plurality of visual enhancement annotations that has a timestamp matching the first point in time, the selected visual enhancement annotation being associated with the audio-visual cue in the media metadata data structure.

3. The method of claim 2, wherein the UI element corresponding to the audio-visual cue is associated with the selected visual enhancement annotation in the media metadata data structure.

4. The method of claim 2, wherein causing the corresponding UI element to be enhanced on the UI of the content platform comprises:
using a visual enhancement setting of the selected visual enhancement annotation to enhance the corresponding UI element, wherein the visual enhancement setting dictates how to enhance the corresponding UI element.

5. The method of claim 4, wherein the visual enhancement setting is one of: illuminating the corresponding UI element or pixels surrounding the corresponding UI element, animating the corresponding UI element, or adding a message next to the corresponding UI element.

6. The method of claim 1, wherein the corresponding UI element is one of a like button, a share button, a subscribe button, a join button, a comment section, or a description section.

7. The method of claim 2, further comprising:
generating the plurality of visual enhancement annotations for the media item, wherein each of the plurality of visual enhancement annotations identify a respective audio-visual cue, a timestamp associated with an occurrence of the respective audio-visual cue within the media item, and a UI element associated with the respective audio-visual cue; and
adding the entry comprising the plurality of visual enhancement annotations for the media item to the media metadata data structure.

8. The method of claim 1, further comprising:
detecting one or more actions of the user; and
prior to causing the corresponding UI element to be enhanced, verifying that enhancing the corresponding UI element is consistent with the one or more actions of the user.

9. The method of claim 1, wherein causing the corresponding UI element to be enhanced on the UI of the content platform further comprises:
ensuring that a number of times the corresponding UI element is enhanced during payback of the media item is below a threshold number.

10. The method of claim 1, wherein the corresponding UI element is enhanced during payback of the media item according to a priority order.

11. The method of claim 1, wherein causing the corresponding UI element to be enhanced on the UI of the content platform comprises:
determining whether a UI enhancement feature is enabled or disabled based on user input or capability of the user device; and
responsive to determining that the UI enhancement feature is enabled, enhancing the corresponding UI element on the UI of the content platform.

12. A system comprising:
a memory device; and
a processing device coupled to the memory device, wherein the processing device is to perform operations comprising:
providing, for presentation on a user device of a user, a user interface (UI) of a content platform to play a media item, the UI comprising a plurality of UI elements;
detecting, during playback of the media item via the UI of the content platform, an occurrence of an audio-visual cue, within the media item, for the user to engage with the UI of the content platform;
identifying, among the plurality of UI elements of the UI, a UI element corresponding to the audio-visual cue for the user to engage with the UI of the content platform; and
causing the corresponding UI element to be enhanced on the UI of the content platform.

13. The system of claim 12, wherein detecting the occurrence of the audio-visual cue within the media item further comprises:
accessing a media metadata data structure comprising a plurality of entries each associated with one of a plurality of media items;
identifying, using an entry associated with the media item in the media metadata data structure, a plurality of visual enhancement annotations each corresponding to one of a plurality of audio-visual cues; and
selecting, at a first point in time during the playback of the media item, one of the plurality of visual enhancement annotations that has a timestamp matching the first point in time, the selected visual enhancement annotation being associated with the audio-visual cue in the media metadata data structure.

14. The system of claim 12, wherein the processing device is to perform operations further comprising:
detecting one or more actions of the user; and
prior to causing the corresponding UI element to be enhanced, verifying that enhancing the corresponding UI element is consistent with the one or more actions of the user.

15. The system of claim 12, wherein causing the corresponding UI element to be enhanced on the UI of the content platform further comprises:
ensuring that a number of times the corresponding UI element is enhanced during payback of the media item is below a threshold number.

16. The system of claim 12, wherein causing the corresponding UI element to be enhanced on the UI of the content platform comprises:
determining whether a UI enhancement feature is enabled or disabled based on user input or capability of the user device; and
responsive to determining that the UI enhancement feature is enabled, enhancing the corresponding UI element on the UI of the content platform.

17. A non-transitory machine-readable storage medium storing instructions which, when executed, cause a processing device to perform operations comprising:
providing, for presentation on a user device of a user, a user interface (UI) of a content platform to play a media item, the UI comprising a plurality of UI elements;
detecting, during playback of the media item via the UI of the content platform, an occurrence of an audio-visual cue, within the media item, for the user to engage with the UI of the content platform;
identifying, among the plurality of UI elements of the UI, a UI element corresponding to the audio-visual cue for the user to engage with the UI of the content platform; and
causing the corresponding UI element to be enhanced on the UI of the content platform.

18. The non-transitory machine-readable storage medium of claim 17, wherein detecting the occurrence of the audio-visual cue within the media item further comprises:
accessing a media metadata data structure comprising a plurality of entries each associated with one of a plurality of media items;
identifying, using an entry associated with the media item in the media metadata data structure, a plurality of visual enhancement annotations each corresponding to one of a plurality of audio-visual cues; and
selecting, at a first point in time during the playback of the media item, one of the plurality of visual enhancement annotations that has a timestamp matching the first point in time, the selected visual enhancement annotation being associated with the audio-visual cue in the media metadata data structure.

19. The non-transitory machine-readable storage medium of claim 18, wherein the UI element corresponding to the audio-visual cue is associated with the selected visual enhancement annotation in the media metadata data structure.

20. The non-transitory machine-readable storage medium of claim 18, wherein causing the corresponding UI element to be enhanced on the UI of the content platform comprises:
determining whether a UI enhancement feature is enabled or disabled based on user input or capability of the user device; and
responsive to determining that the UI enhancement feature is enabled, enhancing the corresponding UI element on the UI of the content platform.
